(19) United States
(12) Patent Application Publication
(10) Pub. No.: US 2026/0101870 A1
(43) Pub. Date: Apr. 16, 2026

(54) APPLICATOR FOR ANIMAL IDENTIFICATION TAG

(71) Applicant: SHEARWELL DATA LIMITED, MINEHEAD, SOMERSET (GB)

(72) Inventors: Mike Fletcher, MINEHEAD, SOMERSET (GB); Thomas Bleloch, MINEHEAD, SOMERSET (GB); Sam WEBBER, MINEHEAD, SOMERSET (GB)

(73) Assignee: SHEARWELL DATA LIMITED, MINEHEAD (GB)

(21) Appl. No.: 19/349,189

(22) Filed: Oct. 3, 2025

(30) Foreign Application Priority Data
Oct. 10, 2024 (GB) 2414905.6

(51) Int. Cl. A01K 11/00

(52) U.S. Cl. CPC A01K 11/002

(57) ABSTRACT

An applicator for an animal identification tag has a first jaw and a second jaw defining a gap for receiving an animal's ear. A pin is mounted to the first jaw, the pin being configured to receive a male part of the tag. The first jaw and the second jaw are movable relative to one another to a closed position to drive the male part of the tag through the animal's ear. The pin is movable relative to the first jaw in a longitudinal direction of the first jaw between a first position and a second position, the second position being further from a proximal end of the first jaw than the first position. When in the first position, an angle of the pin relative to the first jaw is fixed and, when in the second position, the pin is pivotable relative to the first jaw.

### CROSS-REFERENCE

This application claims the benefit of priority from Great Britain Patent Application No. 2414905.6, filed Oct. 10, 2024, which is hereby incorporated by reference as if set forth in its entirety herein.

### FIELD OF THE INVENTION

The present invention relates to an applicator for animal identification tags.

### BACKGROUND

It is well known in the field of animal identification to provide an identification tag, typically attached to the animal's ear. Such tags may comprise two parts (such as a male part and female part) which interlock with one part passing through the animal's ear. Alternatively, a tag may be formed with a flexible connection between the two interlocking parts, i.e. as a single unit.

In order to attach a tag to an animal, an applicator is used which typically drives a spiked male part of the tag through the animal's ear to engage with a female part of the tag on the other side to securely affix the tag to the animal. An applicator usually includes a pair of pivotable jaws which define a gap for receiving the animals ear, and which can be brought together to engage the tag parts through the animal's ear. One of the jaws may include a pin (or rod), on which the spiked male part of the tag can be mounted. For example, the male part of the tag may include a channel extending through it, so that the male part of the tag can be sleeved onto the pin on the jaw. This ensures proper alignment of the male and female parts of the tag when the jaws are brought together.

The present invention has been devised in light of the above considerations.

### SUMMARY OF THE INVENTION

At its most general, the present invention provides an applicator for an animal identification tag having a jaw with a pin for receiving a male part of a tag, where the pin is movable between a first position where its angle relative to the jaw is fixed, and a second position where the pin is pivotable relative to the jaw. This enables rapid and easy release of the tag from the applicator if the animal moves its head during attachment of the tag. Sometimes, when applying a tag to an animal's ear, the animal can suddenly move its head. With a conventional applicator where the pin is rigidly fixed in the jaw, sudden movement of the animal's head can cause the ear tear and/or the applicator to be pulled out of the user's hand which could injure the user. In contrast, with the applicator of the invention, the pin can pivot relative to the jaw in response to a force (e.g. a pulling force) that moves the pin to the second position, enabling immediate release of the tag from the jaws of the applicator. This may prevent injury to the animal's ear and facilitate safe tagging of animals.

According to a first aspect of the invention, there is provided an applicator for an animal identification tag, the applicator comprising: a first jaw and a second jaw defining a gap for receiving an animal's ear; and a pin mounted to the first jaw, the pin being configured to receive a male part of the tag, wherein the first jaw and the second jaw are movable relative to one another to a closed position to drive the male part of the tag through the animal's ear, to thereby attach the tag to the animal's ear; wherein the pin is movable relative to the first jaw such that the pin is movable in a longitudinal direction of the first jaw between a first position and a second position, the second position being further from a proximal end of the first jaw than the first position; wherein, when the pin is in the first position, an angle of the pin relative to the first jaw is fixed and, when the pin is in the second position, the pin is pivotable relative to the first jaw.

Thus, when the pin is in the first position, the pin is rigidly held in place, enabling accurate alignment of the male part of the tag for attachment to the animal's ear. If the animal moves its head away from the jaws after insertion of the male part of the tag though its ear, this will result in a pulling force on the pin, which can cause the pin to move to the second position. Once the pin is in the second position, it can pivot away from the jaws to allow release of the tag from the jaws without injury to the animal or the user. Thus, the tag can be automatically released from the applicator, without the user having to open the jaws. Advantageously, as the second position is spaced distally from the first position this enables increased clearance between the jaws and the pin in the second position, thus facilitating pivoting of the pin even after complete or partial attachment of the tag to the animal's ear. This may avoid the tag getting caught in the jaws when the pin is pivoted, facilitating pivoting of the pin and rapid release of the tag. In particular, moving the pin closer to the distal end of the jaws before pivoting the pin reduces a risk of interference between the tag and the jaws as the pin pivots, thus improving the applicator's ability to rapidly release the tag from the pin and avoiding damage to the applicator.

The applicator of the invention may be used with various types of animal tags. As one example, the animal tag may be a two-part tag comprising the male part and a female part. Alternatively, the animal tag may be provided as a single unit. For example, the male part of the tag may include a blocking element arranged to hold the tag on the animal's ear after passing the male part through the animal's ear. Such a single-unit tag may be referred to as a feedlot tag. As another example, the tag may be a single-unit tag where the male and female part of the tag are connected by a flexible connecting portion.

The first jaw and the second jaw define a gap for receiving an animal's ear. Thus, a depth of the gap may be suitable for receiving an animal's ear.

The first jaw and the second jaw are movable (e.g. pivotable) relative to one another to open and close the gap therebetween. For instance, the first jaw and the second jaw may be movable between an open position and the closed position, where an opening angle (or spacing) between the jaws is larger in the open position than in the closed position. As an example, the first and second jaws may be coupled via one or more pivot joints, to enable movement of the jaws between the open and closed positions.

The applicator may further comprise a pair of handles that are operable to move the jaws relative to one another. For example, a first handle may be coupled to the first jaw, and a second handle may be coupled to the second jaw, e.g. such that the handles can be moved together to close the jaws and moved apart to open the jaws.

The pin on the first jaw is arranged to receive the male part of the tag. The male part of the tag may comprise a stem (or shank, or shaft), which is arranged to pass through the animal's ear. A channel may extend through at least part of the stem, such that the pin can be inserted into the channel to hold the male part of the tag on the first jaw. Thus, the pin may be adapted (e.g. dimensioned, shaped) to fit into the channel in the male part of the tag. The pin may, for example, have a substantially cylindrical shape. The male part of the tag may further comprise a plate from which the stem protrudes. A tip of the stem may be pointed to facilitating piercing the animal's ear.

The pin may be arranged such that, when it is in the first position, it extends from an inner surface of the first jaw towards the second jaw. In this manner, the male part of the tag is driven through the animal's ear when the jaws are moved to the closed position.

When the pin is in the first position, its angle relative to the first jaw is fixed. In other words, the pin is not pivotable relative to the first jaw when in the first position. This serves to ensure accurate alignment of the pin in the first position for effective attachment of the tag.

When the pin is in the first position, it is arranged to attach the tag to the animal's ear, i.e. when the jaws are moved to the closed position. When the pin is in the first position, it may be located in the gap between the jaws.

The angle of the pin may be fixed relative to first jaw via any suitable means. For example, the pin may be rigidly held (or secured) relative to the first jaw when in the first position. This may avoid or minimise any play in the angle of the pin, to ensure accurate alignment of the pin for tagging.

Here, the angle of the pin relative to the first jaw may refer to an angle of a longitudinal axis of the pin relative the inner surface of the first jaw, and/or relative to the longitudinal direction of the first jaw.

In the first position, the angle of the pin relative to the first jaw may be any suitable angle for driving the male part of the tag through the animal's ear when the jaws are moved to the closed position. For example, the pin may extend in a direction (substantially) normal to the inner surface of the first jaw.

The pin is movable in the longitudinal direction between the first position and the second position. Here, the longitudinal direction of the jaw corresponds to a direction linking the proximal end of the jaw to the distal end of the jaw. The longitudinal direction may correspond to a direction of the jaw normal to an axis about which the jaw is pivotable.

The second position of the pin is further from the proximal end of the first jaw than the first position. The second position is spaced in the longitudinal direction from the first position. Thus, the second position may be closer to (or beyond) a distal end of the first jaw.

Here, the proximal end of the jaw may correspond to an end of the jaw that is connected to a handle of the applicator. A pivotable connection between the first jaw and the second jaw may be located at the proximal end of the jaw. The gap between the jaws may be closed at the proximal end, whereas the gap may be open at the distal end of the jaws to enable insertion of the animal's ear into the gap. In use, the proximal end of the jaw may be closer to the user, whilst the distal end of the jaw may be closer to the animal.

In line with the above, when the pin is in the second position, it may be located nearer (or beyond) the opening of the gap between the jaws. Thus, when the pin is moved from the first position to the second position, this may act to at least partially disengage the tag from the second jaw without having to open the jaws, in turn facilitating pivoting of the pin.

When in the second position, the pin is pivotable relative to the first jaw about a pivot axis. The pivot axis may pass through the pin itself, or through a component that is connected to the pin. Thus, the pin can be pivoted (i.e. moved about the pivot axis) to change the angle of the pin relative to the first jaw.

To use the applicator, the male part of the tag is mounted on the pin, with the pin in the first position. The animal's ear can be inserted into the gap between the jaws, with the jaws in the open position. The jaws can then be moved to the closed position, to drive the male part of the tag through the animal's ear and attach the tag. If, during attachment of the tag, the animal pulls their head away from the applicator, this will result in a pulling force on the pin, which may cause the pin to move from the first position to the second position. When in the second position, the pulling force may cause the pin to pivot away from the jaws, so that the male part of the tag can slide off the pin, allowing the tag to be released without having to open the jaws. Following release of the tag, the pin can be returned to the first position to begin another tagging procedure.

The applicator may further comprise a retaining mechanism configured to retain the pin in the first position, and to release the pin from the first position when a pulling force on the pin away from the proximal end of the first jaw exceeds a threshold force. This may ensure that the pin remains in the first position unless a sufficiently large force is exerted on the pin. This may avoid the pin accidentally moving to the second position during normal attachment of the tag. Thus, the retaining mechanism can ensure that the pin is retained in the first position until a pulling force exceeding the threshold force is exerted on the pin. In this manner, the pin may be reliably held in the first position, to allow effective application of the tag to the animal's ear. During or after application of the tag, movement of the animal's head may result on a pulling force on the pin away from the proximal end of the jaw. If the pulling force exceeds the threshold force, the pin moves to the second position, enabling it to pivot to rapidly release the tag from the jaws. The threshold force may thus be set to slightly less than a pulling force that is typically exerted on the pin when the animal moves its head during application of the tag.

Any suitable arrangement of retaining mechanism may be used, examples of which are provided below. As an example, the retaining mechanism may comprise an engagement element configured to exert a retaining force to retain the pin in the first position. Then, a pulling force on the pin exceeding the threshold force may overcome the retaining force such that the pin is released from the first position. The retaining force may, for example, be a frictional force. The retaining force may be applied directly to the pin and/or to a component connected to the pin.

For instance, the engagement element may be in the form of a ball bearing, i.e. the retaining mechanism may comprise a ball bearing arranged to exert a retaining force to retain the pin in the first position.

The retaining mechanism may comprise a ball spring plunger, having a ball bearing arranged to exert a retaining force to retain the pin in the first position.

The retaining mechanism may be adjustable to adjust the threshold force at which the pin is released from the first position. In this manner, the user can adjust the threshold force to adapt the retaining mechanism to difference use contexts. For example, where an animal has a more fragile ear, it may be desirable to reduce the threshold force, to avoid tearing of the ear when the animal moves its head. On the other hand, in some cases it may be desirable to avoid the pin being accidentally pulled into the second position, in which case the threshold force can be increased. Any suitable mechanism for adjusting the threshold force may be used. As an example, the retaining force exerted by the engagement element may be adjustable, to thereby adjust the threshold force.

In some cases, the retaining mechanism may be adjustable to lock the pin in the first position. In this manner, the pin can be prevented from moving to the second position.

The retaining mechanism may comprise a spring arranged to exert a retaining force for retaining the pin in the first position, wherein a length of the spring is adjustable to adjust the threshold force. Thus, for example, by reducing the length of spring (i.e. increasing compression the spring), the retaining force may be increased, thereby increasing the threshold force at which the pin is released from the first position. Conversely, increasing a length of the spring (to reduce its compression) may reduce the retaining force and hence the threshold force. Use of a spring in this manner may facilitate continuous adjustment of the threshold force.

Where the retaining mechanism comprises a ball bearing, the spring may be arranged to press the ball bearing against the pin (or a component connected thereto) when the pin is in the first position.

When the pin is in the second position, the pin may be pivotable relative to the first jaw about an axis that is substantially normal to the longitudinal direction. In other words, the axis about which the pin is pivotable may be substantially normal to the longitudinal direction in which the pin is moveable between the first and second positions. This enables pivoting of the pin away (outwards) from the jaws to facilitate release of the tag.

When the pin is in the second position, the pin may be pivotable relative to the first jaw to a third position where a tip of the pin is located beyond distal ends of the first jaw and the second jaw. In other words, when the pin is pivoted to the third position, the tip of the pin may be located outside the gap between the jaws. Thus, for example, the pin may be pivotable to move the tip away from the proximal end of the first jaw, so that it is no longer located in the gap between the jaws. Thus, when the pin is in the third position, the tip of the pin may be clear of the jaws, facilitating release of the tag from the pin.

The second jaw may comprise a holder for holding a female part of the tag. When the pin is in the first position and the first and second jaws are in the closed position, the pin may be aligned with the holder; and when the pin is in the second position and the first and second jaws are in the closed position, the pin may be located beyond the holder. In this manner, with the pin in the first position, the jaws can be closed to attach the male part of the tag to the female part of the tag. Then, if the pin is moved to the second position, this will cause both the male and female parts to be moved in the longitudinal direction away from the proximal end of the first jaw. As the pin is located beyond the holder in the second position, the female part may no longer be held by the holder when the pin is moved to the second position. In other words, moving the pin from the first position to the second position after connecting the male and female parts of the tag may serve to disengage the female part of the tag from the holder. This may facilitate pivoting of the pin, by avoiding or reducing interference between the female part of the tag and the holder when the pin is pivoted. Disengaging the female part of the tag from the holder prior to pivoting of the pin may also avoid damaging the holder and/or the female part when the pin is pivoted.

The holder may, for example, comprise a holding member (e.g. a clip, prong, clamp or tab) which is arranged to hold the female part of the tag on the second jaw. The holder for the female part may also include a groove or channel in the second jaw, which is arranged to receive a female engagement portion of the female part of the tag.

The holder may be arranged on an inner surface of the second jaw which faces the inner surface of the first jaw across the gap between the jaws.

The female part of the tag may comprise a female engagement portion which is configured to receive and retain a male engagement portion on the male part of the tag. The male engagement portion may be in the form of a spike at a tip of the stem, which is arranged to pierce and pass through the animal's ear.

The pin being located beyond the holder when in the second position may mean that the pin is located further in a distal direction of the jaws compared to the holder. For example, a tip of the pin may be located beyond a distal end of the holder. More generally, in line with the above, when the male and female parts are connected together and the pin is moved from the first position to the second position, the female part of the tag is at least partially disengaged from the holder.

The pin may be connected to a slider element that is slidably mounted in the first jaw, the slider element being slidable in the longitudinal direction to move the pin between the first position and the second position. Such an arrangement may provide accurate and reliable longitudinal motion of pin. This may facilitate movably mounted the pin in the first jaw. In particular, the shape of the slider element may be specifically adapted to allow sliding motion of the slider element relative to the jaw in the longitudinal direction.

The slider element may, for example, be received in a cavity (or groove or channel) defined in the first jaw, with the slider element being slidable along the groove to move the pin between the first and second positions. The groove may extend in a longitudinal direction of the first jaw.

The pin may be connected to the slider element via any suitable means. The pin may be removably connected to the slider, e.g. via a fastener. This may facilitate replacement of the pin. Alternatively, the pin may be provided (or formed) as part of the slider element.

An interference fit may be formed between the slider element and the first jaw when the pin is in the first position. This may serve to ensure that the angle of the pin is rigidly held in place when the pin is in the first position. This may avoid or minimise any play (wobble) in the pin when it is in the first position, to ensure accurate alignment of the pin for attachment of the tag to the animal.

The interference fit between the slider element and the first jaw may ensure a tight fit between the two parts, to avoid any play between the slider element and the first jaw. For instance, where the slider element is received in a cavity (or groove or channel) in the first jaw, a cross-sectional shape of the slider element may (substantially) match a shape of the cavity such that an interference fit is formed between the slider element and the first jaw.

Where the applicator comprises a retaining mechanism, the retaining mechanism may be arranged to engage a surface of the slider element to retain the pin in the first position. Advantageously, the slider element may present a relatively large surface (e.g. compared to the pin) which the retaining mechanism can engage, to thereby retain the pin in the first position. This may enable the pin to be held more stably and reliably in the first position. For instance, the engagement element of the retaining element may be arranged to engage the surface of the slider element, e.g. to apply a retaining force to the slider element.

The surface of the slider element may comprise an engagement feature arranged to engage the engagement element of the retaining mechanism when the pin is in the first position. This may strengthen the engagement between the engagement element and the slider element, and reduce a risk of slippage between the two. For instance, the surface of the slider element may comprise a groove, protrusion, cavity or other engagement feature for engaging the engagement element. Where the engagement element of the retaining mechanism includes a ball bearing, the surface of the slider element may comprise a groove or cavity (or depression) arranged to receive the ball bearing when the pin is in the first position.

The slider element may comprise a pivot axle that is engaged in a channel in the first jaw and arranged to slide along the channel when the pin is moved between the first position and the second position; and when the pin is in the second position, the slider element is pivotable relative to the first jaw about the pivot axle. In this manner, the slider element is structured to provide both the longitudinal and pivoting motion of the pin. In particular, engagement of the axle in the channel (or groove) enables both sliding movement and pivoting movement of the slider element. This may simplify a construction of the applicator.

The axle may have a cylindrical shape which protrudes from a side of the slider element to engage the channel in the first jaw. The axle may be received in a hole defined in a body of the slider element. Alternatively, the axle may be formed as part of the slider element.

The channel may extend in the longitudinal direction of the first jaw such that, when the pin is in the first position, the axle is located at a first (proximal) end of the channel, and when the pin is in the second position, the axle is located at a second (distal) end of the channel. When the axle is at the second end of the channel, the slider element is pivotable relative to the jaw about the axle. The pin, being connected to the slider element, is pivotable with the slider element about the axle relative to the first jaw.

The slider element may comprise a distal portion and the first jaw may comprise an engagement portion arranged to engage a surface of the distal portion of the slider element to block pivoting of the slider element about the pivot axle, and wherein, when the pin is in the second position, the distal portion of the slider element is located beyond a distal end of the engagement portion to allow pivoting of the slider element about the pivot axle. In this manner, the slider element is blocked from pivoting in the first position, so as to hold the angle of the pin fixed to enable attachment of the tag. Sliding the slider element to the second position disengages its distal portion from the engagement portion of the first jaw, to allow the slider element to pivot about the axle.

The engagement portion may comprise a pair of longitudinally extending arms, and wherein the slider element further comprises a proximal portion arranged to fit it a gap between the pair of longitudinally extending arms when the slider element is pivoted about the pivot axle. The distal portion of the slider element may be wider than the gap between the pair of longitudinally extending arms, such that the distal portion of the slider element engages the longitudinally extending arms in the first position, thereby blocking pivoting of the slider element. When the slider element is moved to the second position, the distal portion may be located beyond a distal end of the longitudinally extending arms, such that pivoting of the slider element is no longer blocked. When the slider element is pivoted about the axle, the proximal portion of the slider element can pass through the gap between the longitudinally extending arms.

The pin may be connected to the slider element with a fastener, the fastener being located in the gap between the pair of longitudinally extending arms when the pin is in the first position. This may facilitate access to the fastener, thus facilitating connecting and disconnecting the pin to the slider element, e.g. to replace the pin. For example, in line with the above, the fastener may be a nut that is engaged with an end of the pin.

The invention includes any combination of the features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic side view of an applicator according to an embodiment of the invention;

FIG. 2 shows a schematic perspective view of a tag that can be used with the applicator of FIG. 1;

FIG. 3 shows a schematic perspective view of a first jaw of the applicator of FIG. 1;

FIG. 4 shows an expanded side view of the applicator, where part of the first jaw is shown in cross-section;

FIG. 5 shows a schematic perspective view of a slider element of the applicator of FIG. 1;

FIG. 6 shows a schematic side view of jaws of the applicator of FIG. 1, where a pin of the applicator is in a first position;

FIG. 7 shows a schematic side view of jaws of the applicator of FIG. 1, where the pin of the applicator is in a second position; and

FIG. 8 shows a schematic side view of jaws of the applicator of FIG. 1, where the pin of the applicator is in a third position.

### DETAILED DESCRIPTION OF THE INVENTION

Aspects and embodiments of the present invention will now be discussed with reference to the accompanying figures. Further aspects and embodiments will be apparent to those skilled in the art.

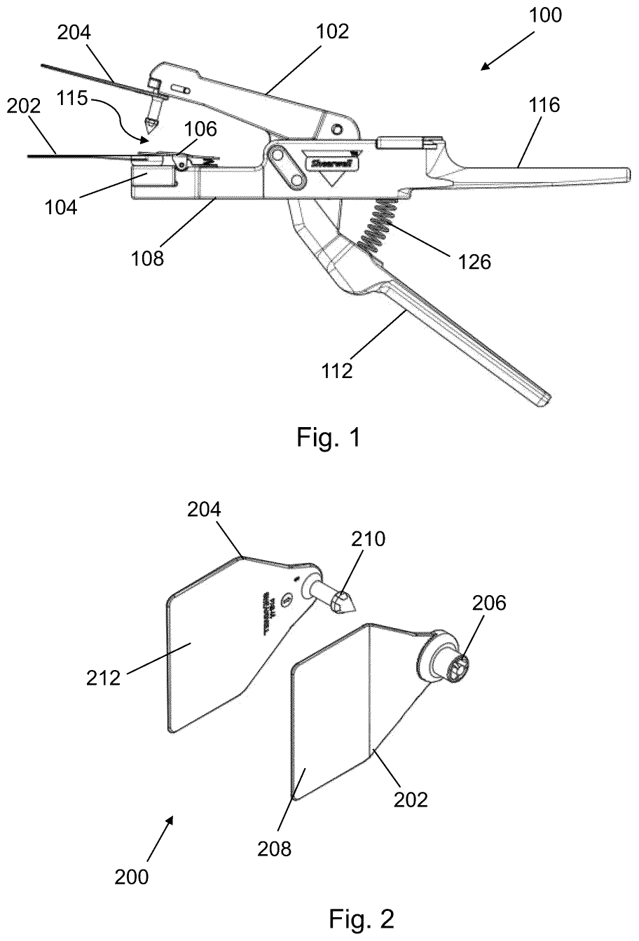

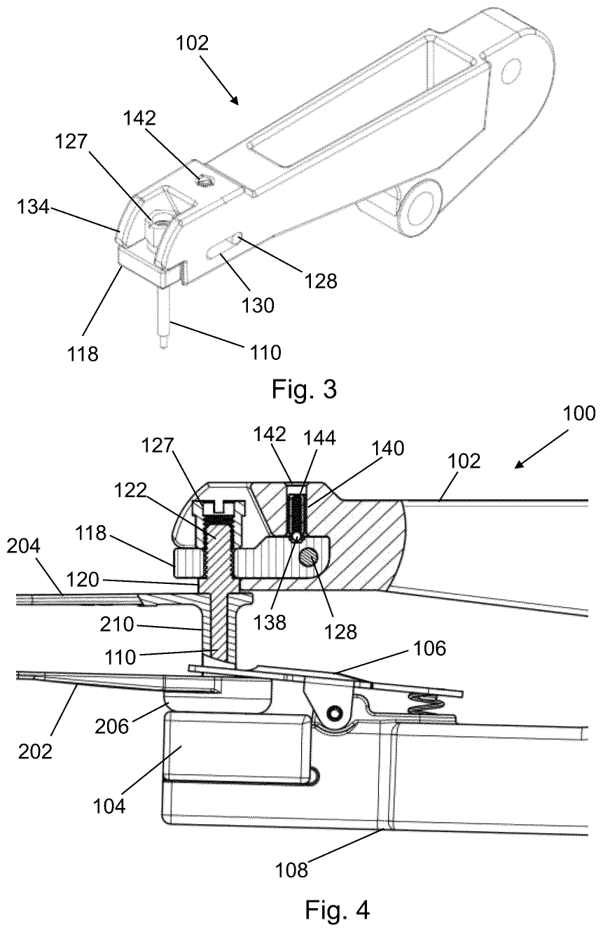

FIG. 1 shows a schematic side view of a tag applicator 100 according to an embodiment of the invention. A schematic perspective of a first jaw 102 of the applicator 100 is shown in FIG. 3, and an expanded side view of the applicator 100 is shown in FIG. 4. In FIG. 4, part of the first jaw 102 is shown in cross-section, with the cross-section being taken along a centre line of the first jaw 102. FIG. 2 shows a schematic perspective view of an example animal identification tag 200 that can be used with the applicator 100.

The animal identification tag 200 including a female part 202, and a male part 204. The tag 200 is attachable to a part of an animal. For example, the tag may be an ear tag for attachment to an ear of the animal. The female part 202 includes a female engagement portion 206 which is connected to a first plate 208. The male part 204 includes a male engagement portion 210 which is connected to a second plate 212, the male engagement portion 202 being engageable in the female engagement portion 102. As shown, the male engagement portion 210 is in the form of a spike, which in use serves to pass through the part (e.g. ear) of the animal, so that the male engagement portion 210 can be engaged with the female engagement portion 206 after being passed through the part of the animal, to secure the tag to the animal. The female engagement portion 206 includes a receptacle which is configured to receive an end of the male engagement portion 206, and to prevent removal of the end of the male engagement portion 206 following insertion. One or both of the first plate 208 and the second plate 212 may have identification information displayed thereon, to enable identification of an animal to which the tag is affixed. The female part 202 and the male part 204 may typically be formed of a plastic material.

The applicator 100 includes a first jaw 102 configured to receive the male part 204 of the tag. The first jaw 102 includes a pin (elongate member, spike) 110 that protrudes from an inner side of the first jaw 102 (see FIGS. 3 and 4). The pin 110 is configured to be inserted into a channel which extends within the male engagement portion 210 of the male part 204 of the tag (see e.g. FIG. 4). In this manner, the male part 204 of the tag can be fitted on to the second jaw 108 by engaging the pin 110 in the channel of the male engagement portion 210. The applicator 100 further includes a second jaw 108, which is configured to receive the female part 202 of the tag 200. In particular, the second jaw 108 includes a groove 104 and a pronged holder (e.g. clip) 106 arranged on an inner side of the first jaw 102. The female engagement portion 206 is receivable in the groove 104, with the pronged holder 106 being arranged to hold (clamp) the female engagement portion in the groove 104, so as to retain the female part 202 on the inner side of the second jaw 108. Together, the jaws 102, 108 define a gap 115 for receiving part of an animal, such as an animal's ear. In particular, the gap 115 is defined between the inner sides (surfaces) of the first and second jaws 102, 108 which face each other across the gap 115. In the example of FIG. 1, the male part 204 of the tag is mounted on the first jaw 102, i.e. the pin 110 is received in the channel in the male engagement portion 210. Likewise, in FIG. 1 the female part 202 is mounted on the second jaw 108, with the female engagement portion 206 is received in the groove 104 and held in place by the pronged holder 106.

The first jaw 102 is connected to a first handle 112, and the second jaw 108 is connected to a second handle 116. The first jaw 102 and the second jaw 108 are pivotable relative to one another by means of the first handle 112 and the second handle 116, to vary a size of the gap 115 between the jaws. In particular, the first jaw 102 and the second jaw 108 are pivotable relative to one another between an open position and a closed position, an opening angle of the jaws being greater in the open position than the closed position. FIG. 1 shows the jaws in the open position, whilst FIGS. 6 to 8 show the jaws in the closed position. The first jaw 102 and the second jaw 108 may be pivotably connected relative to one another via one or more pivot joints. In the example shown, a biasing member (e.g. a spring) 126 is provided between the handles 112, 116 to bias the jaws towards the open position.

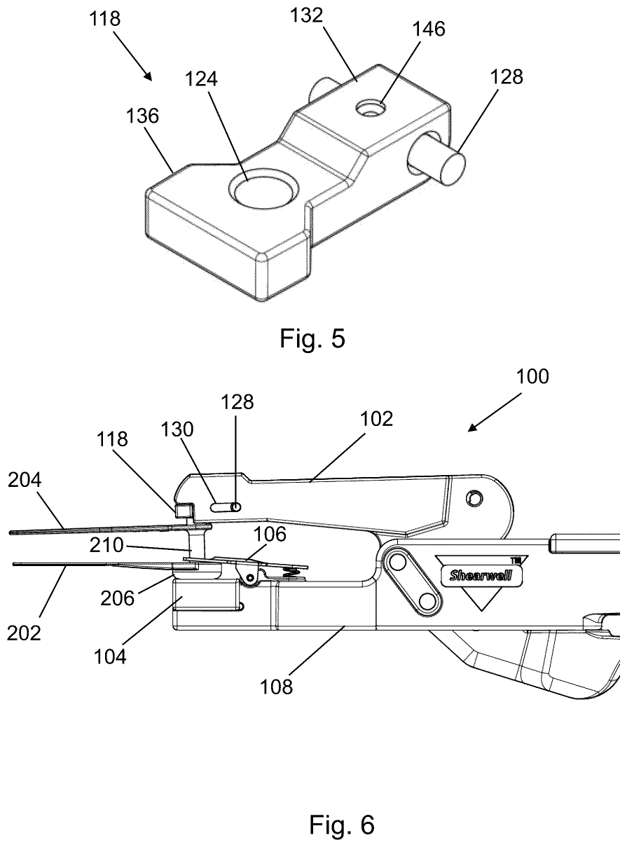

Turning to FIGS. 3 and 4, the first jaw 102 comprises a slider element 118 to which the pin 110 is connected. A schematic perspective view of the slider element 118 on its own is shown in FIG. 5. In the example shown, the pin 110 includes a flange 120 from which a threaded end 122 extends. The threaded end 122 passes through a hole 124 in the slider element, such that a fastener (e.g. a nut) 127 can be engaged with the threaded end 122 to secure the pin 110 to the slider element 118. In other examples, other techniques may be used for securing the pin 110 to the slider element 118.

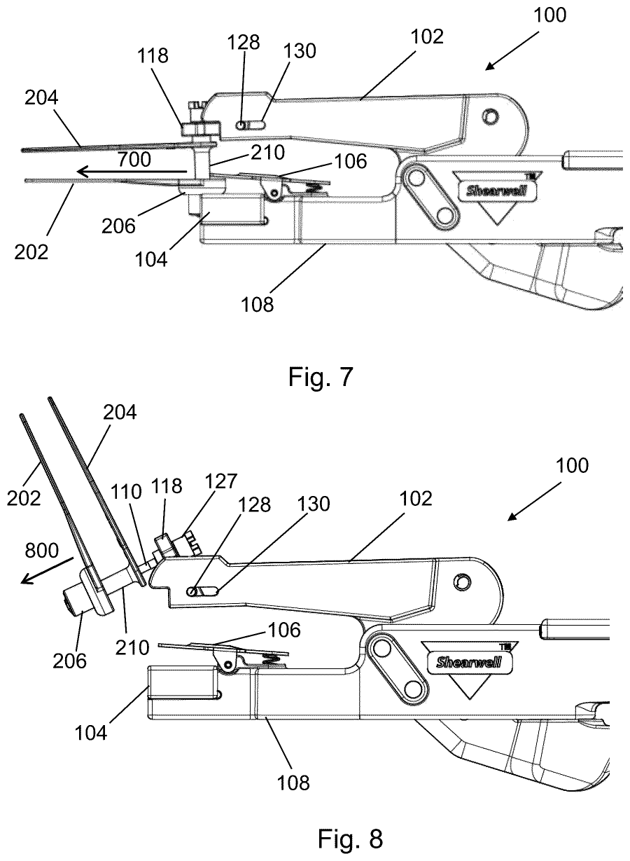

The slider element 118 is slidably mounted in the first jaw 102, such that the slider is movable in a longitudinal direction of the first jaw 102. Here, a longitudinal direction of the first jaw 102 corresponds to a direction along a length of the first jaw, i.e. a direction linking its proximal end (i.e. an end towards the handles) and its distal end (i.e. an end furthest from the handles). In particular, the slider 118 is slidable relative to the first jaw in the longitudinal direction so as to move the pin 110 from a first position to a second position, the second position being further from the proximal end of the first jaw 102 than the first position. FIGS. 1, 3, 4 and 6 show the pin 110 in the first position, whilst FIG. 7 shows the pin 110 in the second position.

The slider element 118 comprises a pivot axle 128 which protrudes laterally on either side of the slider element 118. An axis of the axle 128 is arranged substantially normal to the longitudinal direction along which the slider element 118 is slidable relative to the first jaw 102. As an example, the axle 128 may comprise a cylindrical pin which is press fitted into a through-hole formed through a body of the slider element 118. The axle 128 is engaged in a pair of channels 130 defined in the first jaw 102 on either side of the slider element 118. The channels 130 extend in the longitudinal direction, such that the axle 128 moves along the channels 130 when the slider element 118 moves in the longitudinal direction.

When the pin 110 is in the first position, the slider element 118 is blocked from pivoting about the axle 128. In this manner, an angle of the pin 110 relative to first jaw 102 is held fixed in the first position. For example, as shown in FIG. 4, the pin 110 may extend in a direction substantially normal to the inner surface and/or the longitudinal direction of the first jaw 102 when in the first position. When the pin 110 is in the first position, a proximal portion 132 of the slider element is received in a cavity (or groove or channel) defined in a body of the first jaw 102. In this position, an interference fit may be formed between the proximal portion 132 of the slider element 118 and the cavity in the first jaw 102, to avoid or minimise any play between the slider element 118 and the first jaw 102 in the first position.

In the example shown, the first jaw 102 includes at its distal end a pair of arms 134 which extend in the longitudinal direction of the first jaw 102. The pair of arms 134 are spaced by a gap. The fastener 127 may be located in the gap between the arms 134 when the pin 110 is in the first position. The slider element 118 further comprises a distal portion 136 which has a greater width (in a direction along the axis of the axle 128) than the proximal portion 132. In particular, the width of the distal portion 136 is greater than the gap between the arms 134, such that the distal portion 136 of the slider element 118 engages the arms 134 when the pin 110 is in the first position. Together, engagement of the distal portion 136 of the slider element 118 with the arms 134, and the interference fit of the proximal portion 132 of the slider element 118 in the cavity in the first jaw 102, contribute to blocking pivoting of the slider element 118 about the axle 128 in the first position.

When the pin 110 is moved to the second position (e.g. as shown in FIG. 7), the distal portion 136 of the slider element 118 is located beyond ends of the arms 134 such that the distal position 136 no longer engages the arms 134. Moreover, the proximal portion 132 of the slider element 118 is no longer received in the cavity in the first jaw 102 in the second position. Accordingly, when the pin 110 is in the second position, pivoting of the slider element 118 about the axle 128 is no longer blocked. Thus, when the pin 110 is in the second position, the slider element 118 (together with the pin 110) are pivotable relative to the first jaw 102 about the axle 128. The width of the proximal portion 132 (in the direction along the axis of the axle 128) is smaller than the gap between the arms 134, such that the proximal portion 132 can pass through the gap when the slider element 118 is pivoted.

The applicator 100 further includes a retaining mechanism arranged in the first jaw 102 and configured to retain the pin 110 in the first position. A portion of the first jaw 102 including the retaining mechanism is shown in cross-section in FIG. 4, indicated by the hatched lines. The retaining mechanism is in the form of a ball spring plunger comprising a ball bearing 138 which is arranged to be pressed against a surface of the slider element 118 in the first position, to thereby exert a retaining force on the slider element 118. The ball bearing spring plunger is threadedly engaged in a channel 140 that is in communication with the cavity in the first jaw 102 in which the proximal portion 132 of the slider element 118 is located in the first position. Thus, the ball bearing 138 is arranged for engagement with a surface of the proximal portion 132 of the slider element 118 in the first position. The ball spring plunger comprises a spring 144 which is compressed between a head 142 of the ball spring plunger and the ball bearing 138, so as to exert a force on the ball bearing 138. As shown in FIG. 5, the surface of the proximal portion 132 of the slider element 118 may comprise an engagement feature such as a cup 146 (or a depression, or groove) which is arranged to engage the ball bearing 138.

Accordingly, when the pin 110 is in the first position, the ball bearing 138 engages the surface of the proximal portion 132 of the slider element 118 (e.g. the cup 146) to thereby exert a retaining force on the slider 118 and hold the pin 110 in the first position. Then, to move the pin 110 to the second position, a pulling force on the pin 110 away from the proximal end of the first jaw 102 must overcome the retaining force exerted by the ball bearing 138 on the slider element 118. Thus, the pin 110 will remain in the first position until a pulling force exceeding a threshold force is applied to the pin 110. Here, the threshold force corresponds to a magnitude of the pulling force at which it overcomes the retaining force.

The retaining force exerted by the ball bearing 138 on the slider element 118 can be adjusted by adjusting a position of the ball spring plunger in the channel 140. For example, a screwdriver can be engaged with the head 142 of the ball spring plunger to move the ball spring plunger forwards or backwards along the channel 140. The ball spring plunger can be screwed further into the channel 140 (i.e. moved towards the slider element 118), to increase the retaining force exerted by the ball bearing 138 on the slider element 118. In some cases, the ball spring plunger can be tightened to an extent that the slider element is effectively locked in the first position and prevented from sliding relative to the first jaw 102. Conversely, the ball spring plunger can be moved along the channel 140 away from the slider element 118 to reduce the retaining force exerted by the ball bearing 138 on the slider element 118. The head 142 of the ball spring plunger is accessible on an outer surface of the first jaw 102, to facilitate adjustment of the retaining force.

A use of the applicator 100 is now described. Starting with the configuration shown in FIG. 1, the jaws are in the open position with the male part 204 of the tag mounted on the first jaw 102 and the female part 202 of the tag mounted on the second jaw 108. In particular, the pin 110 is received in the channel male engagement portion 210 to hold the male part 204 of the tag 200 on the first jaw 102. The pronged holder 106 engages the female engagement portion 206 to hold the female part 202 of the tag 200 on the second jaw 108. The pin 110 is in the first position, such that the engagement portion 210 and the female engagement portion 206 are aligned for attachment to one another when the jaws are closed.

To attach the tag 200 to an animal, a part (e.g. ear) of the animal may be placed in the gap 115 between the jaws. The jaws can then be moved to the closed position by squeezing the first and second handles 112, 116 together, which causes the spiked male engagement portion 210 to pass through the part of the animal to engage the female engagement portion 206. FIG. 6 shows a side view of the first and second jaws 102, 108 in the closed position after male and female parts of the tag 200 have been connected together, and with the pin 110 still in the first position. The view of FIG. 4 shows the applicator 100 in the same configuration as FIG. 6. Following attachment of the tag 200 to the animal, the jaws can be returned to the open position, to allow the tag 200 to be released from the applicator 100.

If a pulling force away from the proximal end of the first jaw 102 (i.e. in the direction 700 indicated in FIG. 7) is exerted on the pin 110 which overcomes the retaining force exerted by the retaining mechanism (ball spring plunger) on the slider element 118, the pin 110 is moved from the first position to the second position. FIG. 7 shows a side view of the first and second jaws 102, 108 in the closed position after male and female parts of the tag 200 have been connected together, with the pin 110 in the second position. In other words, the pulling force exerted on the pin 110 causes the slider element 118 to slide away from the proximal end of the first jaw 102, until the pin 110 reaches the second position. In the second position, the axle 128 engages the distal end of the channel 130, which acts as a stop for the longitudinal motion of the slider element 118. In practice, the pulling force on the pin 110 may result from movement of the animal during or after attachment of the tag 200 to the animal. For example, if the animal moves its head during or after attachment of the tag 200 to the animal's ear, this can result in a pulling force on the male engagement portion 206 and hence on the pin 110. If the pulling force is large enough to overcome the retaining force from the retaining mechanism, the pin 110 is moved to the second position as illustrated in FIG. 7.

When the pin 110 is in the second position and the jaws are closed (as in FIG. 7), the pin 110 is located beyond a distal end of the holder 106. In other words, in the second position the pin 110 is located further from the proximal end of the jaws compared to the distal end of the holder 106. As a result, moving the pin 110 to the second position after connection of the male and female parts of the tag 200 cause the female engagement portion 206 to become at least partially disengaged from the holder 106. Indeed, as can be seen in FIG. 7, the pronged holder 106 no longer engages the female engagement portion 206 when the pin 110 is in the second position.

As discussed above, when the pin 110 is in the second position, the slider element 118 is allowed to pivot about the axle 128. In particular, as shown in FIG. 8, the slider element 118 can be pivoted to place the pin 110 in a third position where a tip of the pin 110 is located outside the gap 115 between the jaws. Thus, when the pin 110 is pivoted to the third position, the tip of the pin 110 is clear of the jaws and is not located between the jaws. In this manner, when the pin 110 is in the third position, the male part of the tag 204 can slide off the pin 110 (as indicated by arrow 800 in FIG. 8), enabling rapid release of the tag 200 from the applicator 100 without having to return the jaws to the open position. In FIG. 8, the male engagement portion 210 is shown as partially removed from the pin 110, such that part of the pin 110 is visible. Accordingly, a pulling force which causes the pin 110 to move from the first position to the second position may further cause the pin 110 to pivot to the third position where the tag can be pulled off the pin 110. This allows for rapid and automatic release of the tag 200 from the applicator 100 in case of a sufficient force exerted on the pin 110, thereby avoiding injury to the animal and/or user. Furthermore, as the female engagement portion 206 is disengaged from the holder 106 in the second position (FIG. 7), this facilitates pivoting of the pin 110 to the third position after connection of the male part 204 of the tag to the female part 202 of the tag.

It should be noted that, while the applicator 100 described above is configured for use with a tag having separate male and female parts, applicators according to different embodiments may be adapted for use with different types of tags. For example, an applicator having a first jaw 102 as described above may be used with a single-part tag such as a feedlot tag (which may not have a separate female part). In such a case, the second jaw 108 need not be adapted to hold a female part of the tag.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise.

1. An applicator for an animal identification tag, the applicator comprising:
a first jaw and a second jaw defining a gap for receiving an animal's ear; and
a pin mounted to the first jaw, the pin being configured to receive a male part of the tag, wherein the first jaw and the second jaw are movable relative to one another to a closed position to drive the male part of the tag through the animal's ear, to thereby attach the tag to the animal's ear,
wherein the pin is movable relative to the first jaw such that the pin is movable in a longitudinal direction of the first jaw between a first position and a second position, the second position being further from a proximal end of the first jaw than the first position, and
wherein, when the pin is in the first position, an angle of the pin relative to the first jaw is fixed and, when the pin is in the second position, the pin is pivotable relative to the first jaw.

2. An applicator according to claim 1, further comprising a retaining mechanism configured to retain the pin in the first position, and to release the pin from the first position when a pulling force on the pin away from the proximal end of the first jaw exceeds a threshold force.

3. An applicator according to claim 2, wherein the retaining mechanism is adjustable to adjust the threshold force at which the pin is released from the first position.

4. An applicator according to claim 3, wherein the retaining mechanism comprises a spring arranged to exert a retaining force for retaining the pin in the first position, wherein a length of the spring is adjustable to adjust the threshold force.

5. An applicator according to claim 1, wherein, when the pin is in the second position, the pin is pivotable relative to the first jaw about an axis that is substantially normal to the longitudinal direction.

6. An applicator according to claim 1, wherein, when the pin is in the second position, the pin is pivotable relative to the first jaw to a third position where a tip of the pin is located beyond distal ends of the first jaw and the second jaw.

7. An applicator according to claim 1, wherein:
the second jaw comprises a holder for holding a female part of the tag;
when the pin is in the first position and the first and second jaws are in the closed position, the pin is aligned with the holder; and
when the pin is in the second position and the first and second jaws are in the closed position, the pin is located beyond the holder.

8. An applicator according to claim 1, wherein the pin is connected to a slider element that is slidably mounted in the first jaw, the slider element being slidable in the longitudinal direction to move the pin between the first position and the second position.

9. An applicator according to claim 8, further comprising a retaining mechanism configured to retain the pin in the first position, and to release the pin from the first position when a pulling force on the pin away from the proximal end of the first jaw exceeds a threshold force, wherein the retaining mechanism is arranged to engage a surface of the slider element to retain the pin in the first position.

10. An applicator according to claim 8, wherein an interference fit is formed between the slider element and the first jaw when the pin is in the first position.

11. An applicator according to one of claims 8, wherein:
the slider element comprises a pivot axle that is engaged in a channel in the first jaw and arranged to slide along the channel when the pin is moved between the first position and the second position; and
when the pin is in the second position, the slider element is pivotable relative to the first jaw about the pivot axle.

12. An applicator according to claim 11, wherein the slider element comprises a distal portion and the first jaw comprises an engagement portion arranged to engage a surface of the distal portion of the slider element to block pivoting of the slider element about the pivot axle, and wherein, when the pin is in the second position, the distal portion of the slider element is located beyond a distal end of the engagement portion to allow pivoting of the slider element about the pivot axle.

13. An applicator according to claim 12, wherein the engagement portion comprises a pair of longitudinally extending arms, and wherein the slider element further comprises a proximal portion arranged to fit it a gap between the pair of longitudinally extending arms when the slider element is pivoted about the pivot axle.

14. An applicator according to claim 13, wherein the pin is connected to the slider element with a fastener, the fastener being located in the gap between the pair of longitudinally extending arms when the pin is in the first position.
